(19) United States
(12) Patent Application Publication
(10) Pub. No.: US 2014/0291574 A1
(43) Pub. Date: Oct. 2, 2014

(54) ANODE ACTIVE MATERIAL FOR SECONDARY BATTERY AND METHOD FOR MANUFACTURING SAME

(71) Applicant: MK Electron Co., Ltd., Gyeonggi-do (KR)

(72) Inventors: Soon Ho HONG, Gyeonggi-do (KR); Jong Soo CHO, Seoul (KR); Jeong Tak Moon, Gyeonggi-do (KR)

(21) Appl. No.: 14/304,210

(22) Filed: Jun. 13, 2014

Related U.S. Application Data
(63) Continuation of application No. PCT/KR2012/010150, filed on Nov. 28, 2012.

(30) Foreign Application Priority Data
Dec. 14, 2011 (KR) 10-2011-0134465

(51) Int. Cl. H01M 4/36

(52) U.S. Cl. CPC H01M 4/364
USPC 252/182.1

(57) ABSTRACT

An anode active material for a secondary battery is provided. The anode active material provides high-capacity, high-efficiency, charging and discharging characteristics. The anode active material for a secondary battery may include a silicon single phase and a silicon-metal alloy phase distributed around the silicon single phase. The silicon-metal alloy phase may include copper, iron, titanium and nickel.

### CROSS REFERENCE TO RELATED APPLICATIONS

This application is a continuation of Patent Cooperation Treaty (PCT) international application Serial No. PCT/KR2012/010150, filed on Nov. 28, 2012 and which designates the United States, which claims priority to Korean Patent Application No. 10-2011-0134465, filed on Dec. 14, 2011. The entirety of both Patent Cooperation Treaty (PCT) international application Serial No. PCT/KR2012/010150 and Korean Patent Application No. 10-2011-0134465 are hereby incorporated by reference herein.

### FIELD OF THE INVENTION

The present invention relates to a secondary battery, and in particular, to an anode active material for a secondary battery, which is capable of providing high-capacity, high-efficiency charging and discharging characteristics and a method of manufacturing the anode active material.

### BACKGROUND

Lithium secondary batteries are used in various applications including power sources for portable electronic products, such as mobile phones or notebook computers, as well as middle- and large-sized power sources, such as hybrid electric vehicles (HEV), or plug-in HEVs. Due to the wide application range and an increasing demand therefor, outer shape and size of batteries are variously changed, and higher capacity, longer lifespan, and higher stability are required than in small batteries according to the related art.

Regarding lithium secondary batteries, materials that enable intercalation and deintercalation of lithium ions are often used in a negative electrode and a positive electrode, with a porous separator disposed between the positive electrode and the negative electrode. An electrolytic solution is added thereby completing the lithium secondary batteries, wherein oxidation and reduction occurs at the negative electrode and the positive electrode due to intercalation and deintercalation of lithium ions, thereby generating or consuming electricity.

Graphite, which is widely used as a negative active material for a lithium secondary battery, has a layered structure, which is very suitable for intercalation and deintercalation of lithium ions. Although graphite electrodes have a capacity of approximately 372 mAh/g, alternative electrodes are desirable due to increasing demands for high-capacity lithium batteries. In this regard, there has been undergoing research into developing and commercializing a high-capacity negative active material that forms an electrochemical alloy with lithium ions, such as silicon (Si), tin (Sn), antimony (Sb), or aluminum (Al) is actively performed. However, when Si, Sn, Sb, and Al are charged or discharged due to the electrochemical alloy formation with lithium, a volumetric increase or decrease may occur, and the volumetric change according to charging and discharging may cause deterioration in cyclic characteristics of an electrode with Si, Sn, Sb, and Al as an active material. Additionally, the volumetric change may cause cracks on the surface of an electrode active material. When the cracks are continually formed, the surface of an electrode is fragmented, thereby further deteriorating cyclic characteristics.

### SUMMARY

Anode active materials for a secondary battery are disclosed. The anode active materials provide high capacity, and high efficiency charging and discharging characteristics. A method of preparing the anode active material for a secondary battery is also disclosed. Finally, a secondary battery including the anode active material for a secondary battery is described.

In one aspect, an anode active material for a secondary battery is provided. The anode active material includes one or more first group elements. In one embodiment, the one or more first group elements are in an amount in the range of about 0 at % (atom %) to about 30 at %. The anode active material also includes one or more second group elements. In one embodiment, the one or more second group elements are in an amount in the range of about 0 at % to about 40 at % or less. The anode active material also includes silicon and unavoidable impurities. In one embodiment, the one or more first group elements are selected from the group consisting of titanium (Ti), nickel (Ni), manganese (Mn), aluminum (Al), chrome (Cr), cobalt (Co), zinc (Zn), boron (B), beryllium (Be), molybdenum (Mo), tantalum (Ta), tungsten (W), sodium (Na), strontium (Sr), phosphorus (P), or a combination thereof, and the second group elements comprise copper (Cu), iron (Fe), and a combination thereof.

In one embodiment, the amount of the silicon and unavoidable impurities is in the range of about 60 at % to about 85 at %. In another embodiment, the amount of the silicon and unavoidable impurities are in the range of about 70 at % to about 85 at %.

In one embodiment, the one or more first group elements include Ti and Ni in the same amount. In one embodiment, the one or more second group elements include Cu and Fe in the same amount. In one embodiment, the total amount of the one or more second group elements may be greater than the total amount of the one or more first group elements.

In one embodiment, an amount of the one or more first group elements is in a range of about 0 at % to about 6 at %; an amount of the one or more second group elements is in a range of about 0 at % to about 6 at %; and an amount of the silicon and unavoidable impurities is in the range of about 60 at % to about 85 at %.

According to one aspect, an anode active material for a secondary battery is provided. The anode active material includes a silicon single phase; and a silicon-metal alloy phase that is distributed around the silicon single phase, wherein the silicon-metal alloy phase includes copper, iron, titanium, and nickel.

In one embodiment, an anode active material for a secondary battery including silicon, first group elements, and second group elements is provided. In one embodiment, the first group elements include titanium and nickel, and the second group elements include copper and iron. In one embodiment, when the anode active material for a secondary battery includes copper and iron, the secondary battery has a higher initial discharge capacity, a higher discharge capacity after the 40^{th} cycle, and a higher capacity retention rate after the 40^{th} cycle compared with a secondary battery that does not include copper and iron. In one embodiment, the secondary battery is highly cost-effective because relatively inexpensive copper and iron are used.

### BRIEF DESCRIPTION OF THE DRAWINGS

FIG. 1 is a schematic view illustrating a secondary battery according to one embodiment.

FIG. 2 is a schematic view of an anode in the secondary battery of FIG. 1;

FIG. 3 is a schematic view of a cathode in the secondary battery of FIG. 1;

FIG. 4 is a flowchart illustrating a method of preparing an anode active material in the anode of the secondary battery;

FIG. 5 is a schematic view illustrating a method of preparing an anode active material according to one embodiment;

FIG. 6 is a table comparing the ratio of anode active materials of material compositions;

FIG. 7 is a table comparing the initial discharge capacity, the initial efficiency, the discharge capacity after the 40th cycle, and the capacity retention rate after the 40th cycle of the anode active materials prepared in Examples 1-12 and the Comparative Example;

FIG. 8 is a graph illustrating an initial discharge capacity of the anode active materials prepared in Examples 1-12 and the Comparative Example shown in FIG. 6;

FIG. 9 is a graph illustrating the initial efficiency of the anode active materials prepared in Examples 1-12 and the Comparative Example shown in FIG. 6;

FIG. 10 is a graph illustrating the discharge capacity after the 40th cycle of the anode active materials prepared in Examples 1-12 and the Comparative Example shown in FIG. 6;

FIG. 11 is a graph illustrating the capacity retention rate after the 40th cycle of the anode active materials prepared in Examples 1-12 and the Comparative Example shown in FIG. 6; and

FIGS. 12 and 13 are graphs illustrating the lifespan characteristics of a secondary battery including the anode active material according to one embodiment.

### DETAILED DESCRIPTION

The present inventive concept will now be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the concept of the inventive concept to those of ordinary skill in the art. In the drawings, the thicknesses of layers and regions are exaggerated for clarity. As used herein, the term “and/or” includes any and all combinations of one or more of the associated listed items. Through the specification, like reference numerals denote like elements. Furthermore, in the drawings, elements and regions are schematically illustrated. Accordingly, the inventive concept is not limited to the relative sizes and intervals illustrated in the attached drawings. In embodiments of the present invention, at % (atom %) indicates a percentage point of the number of atoms of a corresponding component in the total number of atoms constituting an alloy.

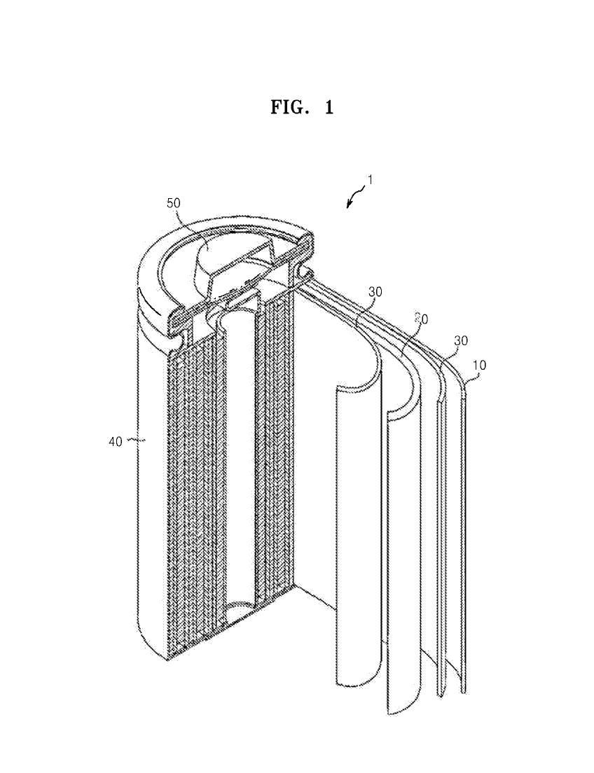

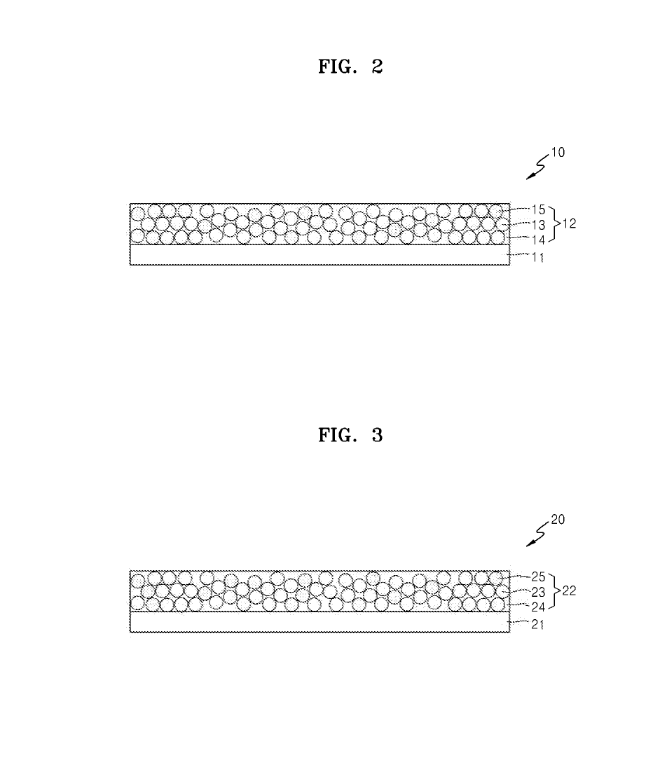

FIG. 1 is a schematic view illustrating a secondary battery 1 according to one embodiment. FIG. 2 is a schematic view illustrating an anode 10 in the secondary battery 1 of FIG. 1. FIG. 3 is a schematic view illustrating a cathode 20 in the secondary battery of FIG. 1.

Referring to FIG. 1, the secondary battery 1 may include the anode 10, the cathode 20, and a separation layer 30 disposed between the anode 10 and the cathode 20, a battery case 40, and a sealing member 50. Also, the secondary battery 1 may further include an electrolyte (not shown) impregnated in the anode 10, the cathode 20, and the separation layer 30. Also, the anode 10, the cathode 20, and the separation layer 30 may be sequentially stacked and spirally wound to fit within the battery case 40. The battery case 40 may be sealed by using the sealing member 50.

In one embodiment, the secondary battery 1 is a lithium secondary battery using lithium as a medium. The secondary battery 1 is selected from the group consisting of a lithium ion battery, a lithium ion polymer battery, and a lithium polymer battery. In one embodiment, the secondary battery 1 is selected depending on the type of separation layer 30 and the electrolyte in the secondary battery 1. In one embodiment, the type of secondary battery 1 is selected from the group consisting of a coin type, a button type, a sheet type, a cylinder type, a flat type, and a cone type. In one embodiment, the type of separation layer 30 depends on the shape of the battery. In one embodiment, the secondary battery 1 is either a bulk type or a thin film type depending on the size of the battery. In FIG. 1, the secondary battery 1 is a cylinder type secondary battery.

In one embodiment, the separation layer 30 is porous. In one embodiment, the separation layer 30 is formed of a single layer or of multiple layers including at least two layers. In one embodiment, the separation layer 30 includes one or more polymer materials. In one embodiment, the one or more polymer materials are selected from the group consisting of polyethylene-based polymers, polypropylene-based polymers, polyvinylidene fluoride-based polymers, and polyolefin-based polymers.

The electrolyte (not shown) impregnated in the anode 10, the cathode 20, and the separation layer 30 may include a non-aqueous solvent and an electrolyte salt. In one embodiment, the non-aqueous solvent is a non-aqueous solvent for a general non-aqueous electrolyte. In one embodiment, the non-aqueous solvent is selected from the group consisting of a carbonate-based solvent, an ester-based solvent, an ether-based solvent, a ketone-based solvent, an alcohol-based solvent, and a non-aprotic solvent. The non-aqueous solvent may be used alone or as a mixture. When the non-aqueous solvent is a mixture, a mixture ratio of the solvents may be appropriately controlled according to desired battery performance.

In one embodiment, the electrolyte salt is an electrolyte salt for a non-aqueous electrolyte solution. In one embodiment, the electrolyte salt has a formula of A⁺B⁻. In one embodiment, A⁺ is an alkali metal cation, wherein the alkali metal cation is selected from the group consisting of Li⁺, Na⁺, or K⁺, and a combination thereof. In one embodiment, B⁻ is an anion, wherein the anion is selected from the group consisting of as PF₆⁻, BF₄⁻, Cl⁻, Br⁻, I⁻, ClO₄⁻, ASF₆⁻, CH₃CO₂⁻, CF³SO₃⁻, N(CF₃SO₂)₂⁻, C(CF₂SO₂)₃⁻, and a combination thereof. In one embodiment, the electrolyte salt is one or more lithium-based salts. In one embodiment, the one or more lithium-based salts are selected from the group consisting of LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(CyF_{2y+1}SO₂) (where, x and y are integers greater than 0), LiCl, LiI, and LiB(C₂O₄)₂. The electrolyte salt may be used alone or as a mixture. Referring to FIG. 2, the anode 10 includes an anode current collector 11 and an anode active material layer 12 disposed on the anode current collector 11. The anode active material layer 12 includes an anode active material 13 and an anode binder 14 attaching particles of the anode active material 13 together.

In one embodiment, the anode active material layer 12 optionally includes an anode conductor 15. Also, although not shown in FIG. 2, the anode active material layer 12 may include an additive, such as a filler or a dispersant. In one embodiment, the anode 10 is formed by preparing an anode active material composition by mixing the anode active material 13, the anode binder 14, and/or the anode conductor 15 in a solvent and then coating the anode active material composition on the anode current collector 11.

In one embodiment, the anode current collector 11 may include a conductive material. In one embodiment, the anode current collector 11 is a thin conductive foil. In one embodiment, the conductive material of the anode current collector 11 is selected from the group consisting of copper, gold, nickel, stainless steel, titanium, and an alloy thereof. In another embodiment, the anode current collector 11 is formed of a polymer including a conductive metal. In another embodiment, the anode current collector 11 is formed by pressing an anode active material.

In one embodiment, the anode active material is an anode active material for a lithium secondary battery. In one embodiment, the anode active material is a material that reversibly intercalates/deintercalates lithium ions. In one embodiment, the anode active material 13 includes silicon and one or more metals. In another embodiment, the anode active material 13 is formed of silicon particles dispersed in a silicon-metal matrix. In one embodiment, the metal is a transition metal. In another embodiment, the one or more metals are selected from the group consisting of Al, Cu, Zr, Ni, Ti, Co, Cr, V, Mn, and Fe. In one embodiment, the silicon particles may have a size of nano-order.

In other embodiments, tin, aluminum, or antimony may be used instead of silicon. For example, in one embodiment, the anode active material is a material that reversibly intercalates/deintercalates lithium ions. In one embodiment, the anode active material 13 includes tin and one or more metals. In another embodiment, the anode active material 13 is formed of tin particles dispersed in a tin-metal matrix. In one embodiment, the metal is a transition metal. In another embodiment, the one or more metals are selected from the group consisting of Al, Cu, Zr, Ni, Ti, Co, Cr, V, Mn, and Fe. In one embodiment, the tin particles may have a size of nano-order.

In another embodiment, the anode active material is a material that reversibly intercalates/deintercalates lithium ions. In one embodiment, the anode active material 13 includes aluminum and one or more metals. In another embodiment, the anode active material 13 is formed of aluminum particles dispersed in an aluminum-metal matrix. In one embodiment, the metal is a transition metal. In another embodiment, the one or more metals are selected from the group consisting of Al, Cu, Zr, Ni, Ti, Co, Cr, V, Mn, and Fe. In one embodiment, the aluminum particles may have a size of nano-order.

In another embodiment, the anode active material is a material that reversibly intercalates/deintercalates lithium ions. In one embodiment, the anode active material 13 includes antimony and one or more metals. In another embodiment, the anode active material 13 is formed of antimony particles dispersed in an antimony-metal matrix. In one embodiment, the metal is a transition metal. In another embodiment, the one or more metals are selected from the group consisting of Al, Cu, Zr, Ni, Ti, Co, Cr, V, Mn, and Fe. In one embodiment, the antimony particles may have a size of nano-order.

In one embodiment, the anode active material 13 includes silicon, one or more first group elements, and one or more second group elements. In one embodiment, the amount of the one or more first group metals of the anode active material 13 is in the range of about 0 at % to about 30 at %. In one embodiment, the one or more first group elements is selected from the group consisting of titanium (Ti), nickel (Ni), manganese (Mn), aluminum (Al), chrome (Cr), cobalt (Co), zinc (Zn), boron (B), beryllium (Be), molybdenum (Mo), tantalum (Ta), tungsten (W), sodium (Na), strontium (Sr), phosphorus (P), and a combination thereof. In one embodiment, the amount of the one or more second group metals of the anode active material 13 is in the range of about 0 at % to about 40 at %. In one embodiment, the second group elements are selected from the group consisting of copper (Cu), iron (Fe), and a combination thereof. In one embodiment, the amount of the silicon and unavoidable impurities of the anode active material 13 is in the range of about 60 at % to about 85 at %. In one embodiment, the amount of the silicon and unavoidable impurities is in the range of about 70 at % to about 85 at %.

In one embodiment, the amount of the one or more first group elements of the anode active material 13 is in the range of about 0 at % to about 6 at %, the amount of the one or more second group elements is in the range of about 0 at % to about 34 at %, and the amount of silicon and unavoidable impurities is in the range of about 60 at % to about 85 at %. In one embodiment, the amount of the silicon and unavoidable impurities is in the range of about 70 at % to about 85 at %. In one embodiment, the one or more first group elements include titanium (Ti) and nickel (Ni) in the same amount. In one embodiment, the amount of Ti and Ni are each about 3 at %. In one embodiment, the one or more second group elements include copper (Cu) and iron (Fe) in the same amount. In another embodiment, the one or more second group elements include Cu and Fe in different amounts. In one embodiment, the total amount of the one or more second group elements is greater than the total amount of the one or more first group elements.

In one embodiment, the anode binder 14 attaches particles of the anode active material 13 together. In one embodiment, the anode binder 14 attaches the anode active material 13 to the anode current collector 11. In one embodiment, the anode binder 14 includes a polymer. In one embodiment, the polymer is selected from the group consisting of polyimide, polyamide-imide, polybenzimidazole, polyvinyl alcohol, carboxymethyl cellulose, hydroxypropyl cellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene-butadiene, acrylated styrene-butadiene, and an epoxy resin.

In one embodiment, the anode conductor 15 provides conductivity to the anode 10. In another embodiment, the anode conductor 15 is formed of a conductive material that does not cause chemical change to the secondary battery 1. In another embodiment, the anode conductor 15 includes a conductive material including a carbon-based material, wherein the carbon-based material is selected from the group consisting of graphite, carbon black, acetylene black, and carbon fibers; a metal-based material, wherein the metal-based material is selected from the group consisting of copper, nickel, aluminum, and silver; a conductive polymer material, such as a polyphenylene derivative; or a mixture thereof.

Referring to FIG. 3, the cathode 20 includes a cathode current collector 21 and a cathode active material layer 22 disposed on the cathode current collector 21. The cathode active material layer 22 includes a cathode active material 23 and a cathode binder 24 that attaches particles of the cathode active material 23. In one embodiment, the cathode active material layer 22 optionally includes a cathode conductor 25. Also, although not shown in FIG. 3, the cathode active material layer 22 may further include an additive, such as a filler or a dispersant. In one embodiment, the cathode 20 is formed by preparing a cathode active material composition by mixing the cathode active material 23, the cathode binder 24, and/or the cathode conductor 25 in a solvent and then coating the cathode active material composition on the cathode current collector 21.

In one embodiment, the cathode current collector 21 is a thin conductive foil. In one embodiment, the cathode current collector 21 includes a conductive material. In one embodiment, the conductive material of the cathode current collector 21 is selected from the group consisting of aluminum, nickel, and an alloy thereof. In another embodiment, the cathode current collector 21 is formed of a polymer including a conductive metal. In another embodiment, the cathode current collector 21 is formed by pressing a cathode active material.

In one embodiment, the cathode active material 23 is a cathode active material for a lithium secondary battery. In one embodiment, the cathode active material 23 includes a material capable that reversibly intercalates/deintercalates lithium ions. In one embodiment, the cathode active material 23 includes a lithium-containing transition metal oxide or a lithium-containing transition metal sulfide. In one embodiment, the cathode active material 23 includes at least one of LiCoO₂, LiNiO₂, LiMnO₂, LiMn₂O₄, Li(NiₐCo_{b}Mn_{c})O₂ (where, 0<a<1, 0<b<1, 0<c<1, a+b+c=1), LiNi_{1-y}Co_{y}O₂, LiCo_{1-y}Mn_{y}O₂, LiNi_{1-y}Mn_{y}O₂ (where, 0≦Y<1), Li(NiₐCo_{b}Mn_{c})O₄ (where, 0<a<2, 0<b<2, 0<c<2, a+b+c=2), LiMn_{2-z}Ni_{z}O₄, LiMn_{2-z}Co_{z}O₄ (where, 0<z<2), LiCoPO₄, and LiFePO₄.

In one embodiment, the cathode binder 24 attaches the particles of the cathode active material 23 together and attaches the cathode active material 23 to the cathode current collector 21. In another embodiment, the cathode binder 24 is a polymer. In one embodiment, the polymer is selected from the group consisting of polyimide, polyamide-imide, polybenzimidazole, polyvinyl alcohol, carboxymethyl cellulose, hydroxypropyl cellulose, polyvinyl chloride, carboxylated polyvinyl chloride, polyvinyl fluoride, ethylene oxide, polyvinylpyrrolidone, polyurethane, polytetrafluoroethylene, polyvinylidene fluoride, polyethylene, polypropylene, styrene-butadiene, acrylated styrene-butadiene, and an epoxy resin.

In one embodiment, the cathode conductor 25 provides conductivity to the cathode 20. In one embodiment, the cathode conductor 25 is formed of a conductive material that does not cause chemical change to the secondary battery 1. In one embodiment, the cathode conductor 25 includes a conductive material including a carbon-based material, wherein the carbon-based material is selected from the group consisting of graphite, carbon black, acetylene black, and carbon fibers; a metal-based material, wherein the metal-based material is selected from the group consisting of copper, nickel, aluminum, and silver; a conductive polymer material, such as a polyphenylene derivative; or a mixture thereof.

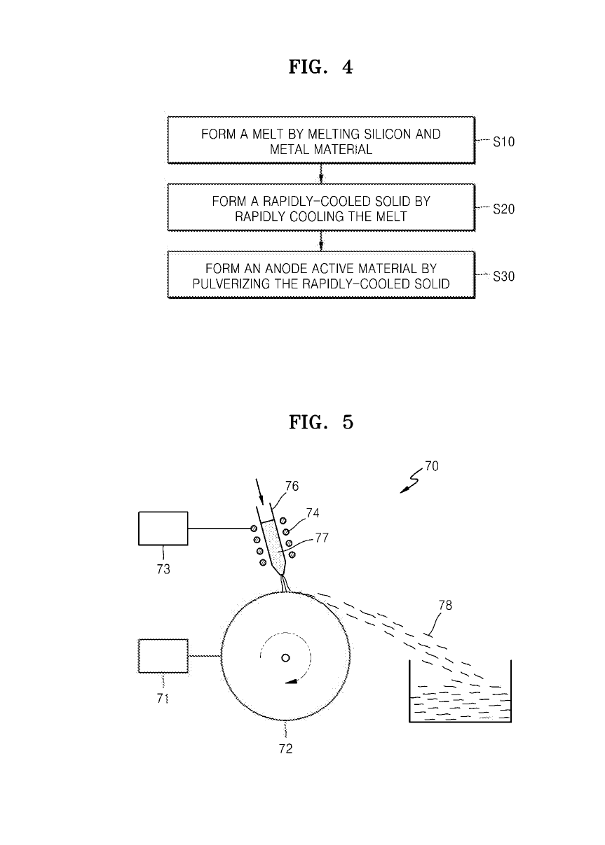

FIG. 4 is a flowchart illustrating a method of preparing the anode active material 13 included in the anode 10 of the secondary battery 1.

Referring to FIG. 4, a melt is formed by the step of melting silicon and a metal material together (S10). In one embodiment, the melting process step is performed by the step of inducing heat generation of silicon or a metal material caused by a high frequency induction using a high frequency electric induction furnace. In another embodiment, the melt is formed by the step of using an arc-melting method.

In some embodiments, the metal material is selected from the group consisting of titanium (Ti), nickel (Ni), manganese (Mn), aluminum (Al), chrome (Cr), cobalt (Co), zinc (Zn), boron (B), beryllium (Be), molybdenum (Mo), tantalum (Ta), tungsten (W), sodium (Na), strontium (Sr), phosphorus (P), copper(Cu), and iron(Fe).

In one embodiment, the melt includes one or more first group elements in an amount in the range of about 0 at % to about 30 at %. In one embodiment, the one or more first group elements is selected from the group consisting of titanium (Ti), nickel (Ni), manganese (Mn), aluminum (Al), chrome (Cr), cobalt (Co), zinc (Zn), boron (B), beryllium (Be), molybdenum (Mo), tantalum (Ta), tungsten (W), sodium (Na), strontium (Sr), phosphorus (P), and a combination thereof. In one embodiment, the melt includes one or more second group elements in an amount in the range of about 0 at % to about 40 at %. In one embodiment, the one or more second group element is selected from the group consisting of copper (Cu), iron (Fe), and a combination thereof. In one embodiment, the melt includes silicon and unavoidable impurities in an amount in the range of about 60 at % to about 85 at %.

In one embodiment, the amount of the silicon and unavoidable impurities is in the range of about 70 at % to about 85 at %.

A rapidly-cooled solid is formed by the step of rapidly cooling the melt (S20). In one embodiment, the rapidly-cooling process step is performed by using a melt spinner shown in FIG. 5. The rapidly-cooled solid is prepared by using other methods. For example, an atomizer may be used, followed by the use of a melt spinner. The rapidly-cooled solid may include a silicon single phase and a silicon-metal alloy phase.

In one embodiment, the method includes optionally heat-treating the rapidly-cooled solid. A crystal or a phase included in the rapidly-cooled solid may be recrystallized and/or experience grain-growth by the heat-treating process step. In one embodiment, the heat-treating process step is performed under vacuum conditions, in an inert atmosphere including nitrogen, argon, helium, or a mixture thereof, or in a reducing atmosphere including hydrogen. In another embodiment, the heat-treating process step is performed in vacuum or in a manner of circulating inert gas, such as nitrogen, argon, or helium. In one embodiment, the heat-treating process step is performed at a temperature in a range of about 400° C. to about 800° C. for about 1 minute to about 60 minutes. In one embodiment, the method includes a cooling step that cools the solid after the heat-treating process step. In one embodiment, the solid is cooled at a cooling rate in a range of about 4° C./min to about 20° C./min In one embodiment, the heat-treating temperature is at least about 200° C. lower than a melting temperature of the rapidly-cooled solid. Microstructure characteristics of the rapidly-cooled solid may change due to the heat-treating process.

In one embodiment, an anode active material is formed by a step of pulverizing the rapidly-cooled solid (S30). The pulverized anode active material may be a powder having a diameter of about several tens to about several hundreds of micrometers. In one embodiment, the powder has a diameter in a range of about 1 μm to about 10 μm. In another embodiment, the powder has a diameter in the range of about 2 μm to about 4 μm. In one embodiment, the pulverizing process step is performed by using a known process, such as a milling process or a ball milling process, to pulverize an alloy to an alloy power. In one embodiment, the time for the ball milling process is varied to control the size of the pulverized powder. In one embodiment, the rapidly-cooled solid is ball milled in the time range of about 20 hours to about 50 hours so that an anode active material is formed of a powder having a particle diameter of about several micrometers.

The anode active material may correspond to the anode active material described in FIG. 1. In one embodiment, the anode active material is mixed with the anode binder 14 to form a slurry as described in FIG. 1. In one embodiment, the slurry is coated on the anode current collector 11 to manufacture the anode 10 of the secondary battery 1.

FIG. 5 is a schematic view illustrating a method of preparing the anode active material.

Referring to FIG. 5, the anode active material is formed by using a melt spinner 70. The melt spinner 70 includes a cooling roll 72, a high frequency induction coil 74, and a tube 76. In one embodiment, the cooling roll 72 is formed of a metal with a high thermal conductivity and high thermal shock resistance. In one embodiment, the metal is formed of copper or a copper alloy. In one embodiment, the cooling roll 72 rotates at a high speed by a rotation unit 71, such as a motor. In one embodiment, the speed is in a range of about 1000 rpm (revolution per minute) to about 5000 rpm. In the high frequency induction coil 74, high frequency electric current flows through by a high frequency induction unit (not shown), thereby induced high frequency to a material inserted into the tube 76. For cooling purposes, a cooling medium flows through the high frequency induction coil 74. In one embodiment, the tube 76 is formed of a material having a low reactivity with the inserted material and high heat-resistance, such as quartz or refractory glass. In the tube 76, the materials (e.g., silicon and a metal material) to be melted are inserted. The high frequency induction coil 74 induces high frequency. The high frequency induction coil 74 is rolled around the tube 76 and melts the material inserted in the tube 76 to form a melt 77 in a liquid phase or a phase having fluidity. In one embodiment, an optional vacuum condition or an inert atmosphere of the tube 76 is used to prevent unwanted oxidation of the melt 77. When the melt 77 is formed, a compressed gas (e.g., an inert gas, such as argon or nitrogen) is supplied (indicated by an arrow) into the tube 76 from one end of the tube 76, and the melt 77 is discharged through a nozzle formed on the other end of the tube 76 by the compressed gas. The melt 77 discharged from the tube 76 contacts the rotating cooling roll 72 and is rapidly cooled by the cooling roll 72 to form a rapidly-cooled solid 78. In one embodiment, the rapidly-cooled solid 78 has a shape of a ribbon, a flake, or a powder. In one embodiment, the melt 77 is rapidly cooled at a fast cooling speed by rapid solidification due to the cooling roll 72. In one embodiment, the cooling speed is in a range of about 10³° C./second to about 10⁷° C./second. In one embodiment, the cooling speed varies depending on the rotation speed, the material, or the temperature of the cooling roll 72.

Since a silicon single phase may rapidly precipitate in a melt when a rapidly-cooled solid is formed when a melt spinner is used, the silicon single phase may be homogeneously dispersed inside a silicon-metal alloy phase by forming an interface with the silicon-metal alloy phase in the rapidly-cooled solid. In one embodiment, a dopant is added to accelerate the miniaturization of the silicon single phase.

### EXAMPLES

Other uses, embodiments and advantages of the anode active material for secondary batteries and methods for manufacturing the anode active material are further illustrated by the following examples, but the particular materials and amounts cited in these examples, as well as other conditions and details, should not be construed to unduly limit the anode active materials.

### 1. Preparation of Examples

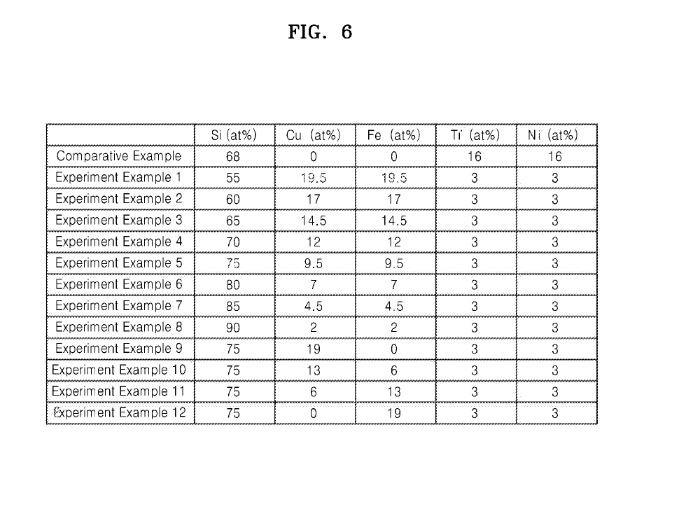

FIG. 6 is a table comparing the ratio of anode active materials in different material compositions.

Melts of silicon-metal alloy phases having atomic percentages (at %) were prepared in Examples 1 to 12. For example, according to Example 1, a melt was prepared by mixing about 19.5 at % of copper, about 19.5 at % of iron, about 3 at % of titanium, about 3 at % of nickel, and about 55 at % of silicon. That is, titanium and nickel were selected as the first group elements in the same amount in the melt. Further, copper and iron were selected as the second group elements.

In each of Examples 1 to 12, the amounts of titanium and nickel were maintained at same amount of about 3 at %. In Examples 1 to 8, amounts of copper and iron were maintained the same, and the amounts of copper and iron decreased as an amount of silicon increased. However, in Examples 9 to 12, an amount of silicon was fixed to about 75 at %, and amounts of copper and iron were varied.

For the Comparative Example, a melt was prepared by mixing about 16 at % of titanium, about 16 at % of nickel, and about 68 at % of silicon. In the Comparative Example, copper and iron were not mixed.

After preparing rapidly-cooled solids by rapidly solidifying the melts with the atomic percentages as described above, the rapidly-cooled solids were ball-milled for about 48 hours to form an anode active material in a powder. The anode active materials obtained may have the silicon single phases that were homogeneously dispersed in the silicon-metal alloy phases.

### 2. Preparation of Half-Cells

To evaluate electrochemical characteristics of the anode active materials prepared in the manner described above, half-cells were prepared. Lithium was used as a reference electrode. The anodes prepared by adding a binder and a conducting agent to the anode active materials prepared in Examples 1 to 12 were used as measurement electrodes to prepare coin cells.

### 3. Charging and Discharging Characteristics Evaluation

An initial discharge capacity, an initial efficiency, a discharge capacity after the 40^{th} cycle, and a capacity retention rate after the 40^{th} cycle of the half-cells prepared in the manner described above were measured. Here, the steps of charging the first and second cycles and the step of discharging the half-cells were performed at a current density of about 0.1 C and about 0.2 C, respectively. The step of charging the third cycle and discharging the half-cells were performed at a current density of about 1.0 C.

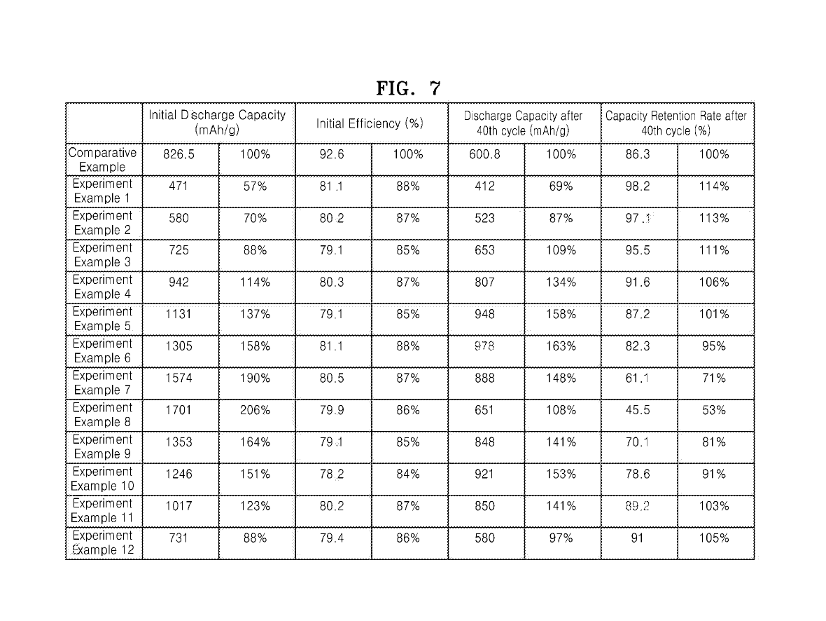

FIG. 7 is a table comparing an initial discharge capacity, an initial efficiency, a discharge capacity after the 40^{th} cycle, and a capacity retention rate after the 40^{th} cycle of the half-cells prepared in Examples 1 to 12 of FIG. 6 and the Comparative Example. The values represented by percentages in FIG. 7 are values compared to that of the Comparative Example.

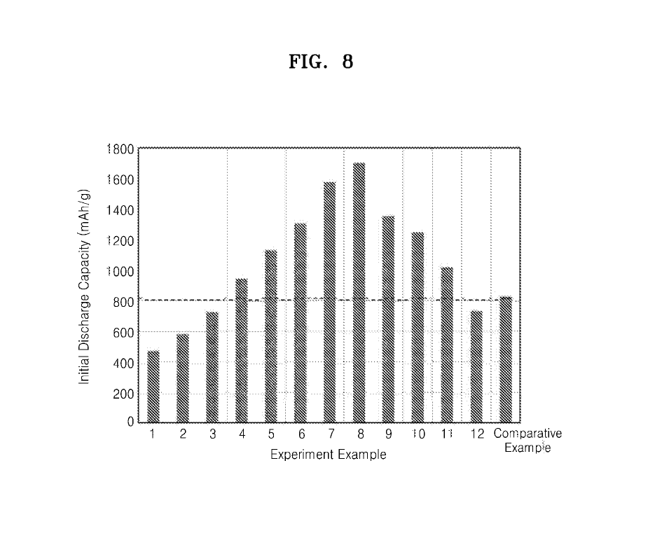

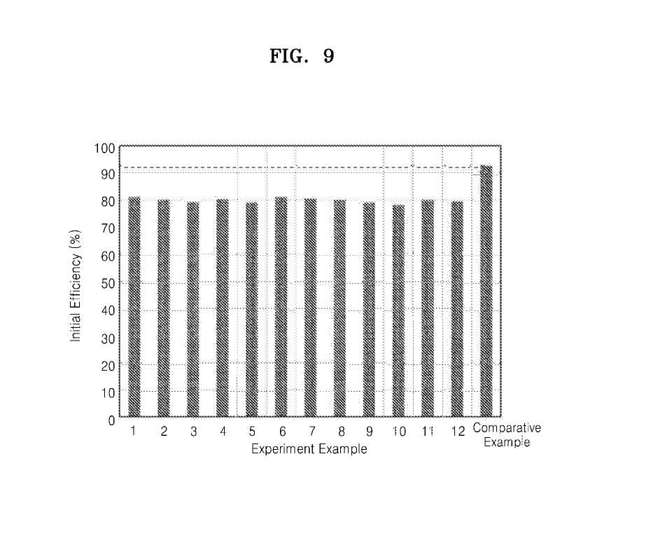

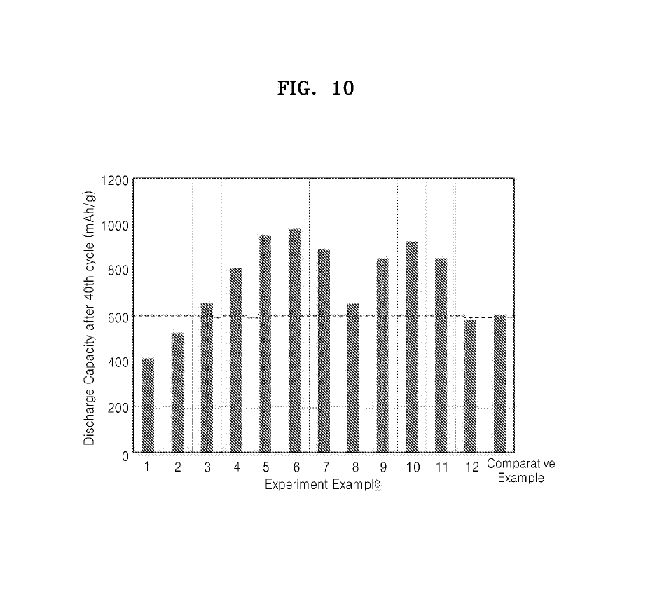

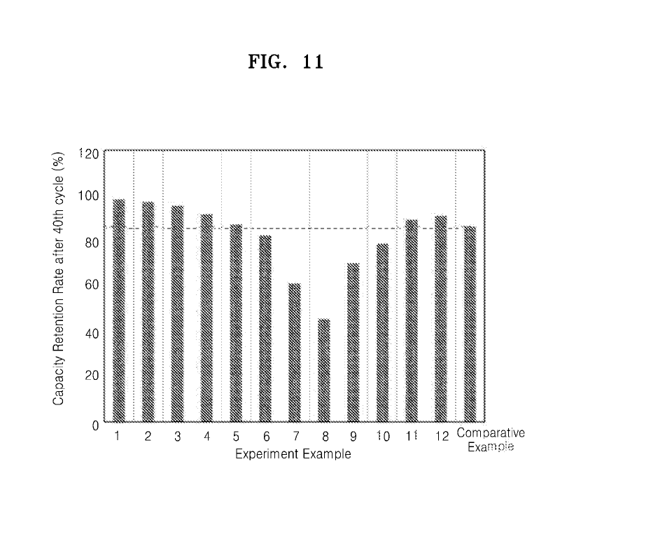

FIG. 8 is a graph showing the initial discharge capacity of the half-cells prepared in Examples 1 to 12 of FIG. 6 and in the Comparative Example. FIG. 9 is a graph showing the initial efficiency of the half-cells prepared in Examples 1 to 12 of FIG. 6 and in the Comparative Example. FIG. 10 is a graph showing the discharge capacity after the 40th cycle of the half-cells prepared in Examples 1 to 12 of FIG. 6 and the Comparative Example. FIG. 11 is a graph showing the capacity retention rate after 40th cycle of the half-cells prepared in Examples 1 to 12 of FIG. 6 and the Comparative Example.

Referring to FIGS. 7 and 8, the initial discharge capacity of the cell prepared in the Comparative Example was about 826.5 mAh/g. Initial discharge capacities of the cells prepared in Examples 4, 5, 6, 7, 8, 9, 10, and 11 were higher than that of the cell prepared in the Comparative Example. However, initial discharge capacities of the cells prepared in Examples 1, 2, 3, and 12 were relatively lower than that of the cell prepared in the Comparative Example.

That is, when the silicon content was in the range of about 70 at % to about 90 at %, the initial discharge capacity of the cells was higher than that of the cell prepared in the Comparative Example. Also, as the content of the silicon increased, the initial discharge capacity increased. When the silicon content was about 90 at % (Example 8), the initial discharge capacity was about 1701 mAh/g, which was the highest initial discharge capacity.

When the silicon content was fixed at about 75 at % (Examples 9 to 12), initial discharge capacities of the cells were higher than that of the cell prepared in the Comparative Example, except for the cell which did not include copper (Example 12). As the content of copper increased, the initial discharge capacity of the cells increased.

Referring to FIGS. 7 and 9, the initial efficiency of all the cells prepared in Examples decreased compared to the initial efficiency of the cell prepared in the Comparative Example. The values of the initial efficiency of the Examples were about 85% of the initial efficiency of the cell prepared in the Comparative Example.

Referring to FIGS. 7 and 10, the discharge capacity after the 40th cycle of the cell prepared in the Comparative Example was about 600.8 mAh/g. Discharge capacities after the 40th cycle of the cells prepared in Examples 3, 4, 5, 6, 7, 8, 9, 10, and 11 were higher than that of the cell prepared in the Comparative Example. However, discharge capacities after 40^{th} cycle of the cells prepared in Examples 1, 2, 3, and 12 were lower than that of the cell prepared in the Comparative Example.

That is, when the silicon content was in the range of about 65 at % to about 90 at %, a discharge capacity after the 40^{th} cycle of the cells was higher than that of the cell prepared in the Comparative Example. Also, when a silicon content was about 80 at % (Example 6), a discharge capacity after the 40th cycle of the cell was about 978 mAh/g, which was the highest discharge capacity. When the silicon content was increased or decreased from about 80 at %, the discharge capacity after the 40^{th} cycle of the cell decreased.

Also, when the silicon content was fixed at about 75 at % (Examples 9 to 12), the discharge capacity after 40^{th} cycle of the cells was relatively higher than that of the cell prepared in the Comparative Example, except that of the cell not including copper (Example 12). When the copper content was about 13 at % and the iron content was about 6 at % (Example 10), the cell had the highest discharge capacity after the 40^{th} cycle. When copper was not included in the cell (as in Example 12), the discharge capacity after 40^{th} cycle was about 97% of the cell prepared in the Comparative Example.

Referring to FIGS. 7 and 11, the capacity retention ratio after the 40^{th} cycle of the cells prepared in Examples 1, 2, 3, 4, 5, 11, and 12 was higher than that of the cell prepared in the Comparative Example. However, the capacity retention ratio after the 40^{th} cycle of the cells prepared in Examples 1, 6, 7, 8, 9, and 10 was higher than that of the cell prepared in the Comparative Example.

That is, as the silicon content increased, the capacity retention rate after the 40th cycle of the cells decreased, and the cells had the lowest value of about 45.5% at the silicon content of about 90 at %.

Also, when the silicon content was fixed at about 75 at % (Examples 9 to 12), the capacity retention rate increased as the content of iron increased. When the iron content was about 90 at %, the capacity retention rate of the cell was a relatively high value, such as about 105%.

In this regard, the result of putting changes in the characteristics of cells according to compositions of the anode active material together may be as follows.

When the silicon content in the anode active material was in the range of about 70 at % to about 75 at % (Examples 4 and 5), the initial discharge capacities, the discharge capacities after the 40^{th} cycle, and the capacity retention rate after the 40^{th} cycle were increased compared to those of the cell prepared in the Comparative Example.

When the silicon content in the anode active material was in the range of about 60 at % to about 65 at % (Examples 2 and 3), the initial efficiencies and the initial discharge capacities were lower than those of the cell prepared in the Comparative Example. However, the discharge capacity after the 40^{th} cycle of the cell prepared in Example 3 was greater than that of the cell prepared in the Comparative Example. The capacity retention rates after the 40^{th} cycle of the cells prepared in Examples 2 and 3 were relatively larger than that of the cell prepared in the Comparative Example. Moreover, because the cells prepared in Examples 2 and 3 included copper or iron, instead of titanium or nickel, they were cost-effective.

When the silicon content in the anode active material was in the range of about 80 at % to about 85 at % (Examples 6 and 7), the initial efficiencies and the capacity retention rates were lower than those of the cell prepared in the Comparative Example. However, the initial discharge capacity and the discharge capacity after the 40^{th} cycle were increased compared to those of the cell prepared in the Comparative Example.

Therefore, the silicon content may be within the range of about 60 at % to about 85 at %. The component ratios of Examples 2 to 7 may be applied to the anode active material according to an inventive concept of the present invention. Also, the silicon may be included at a content of about 70 at % or more to about 85 at % or less. Further, the silicon content may include unavoidable impurities.

However, copper tends to increase a discharge capacity of an anode active material, and iron tends to increase a capacity retention rate. Therefore, as the contents of copper and iron change, characteristics of the anode active material change. Even when the characteristics are relatively low compared to those of a cell prepared in the Comparative Example, the values are maintained at about 80% or higher. Thus, the composition ratios of Examples 9 to 12 may be applied to the anode active material according to an inventive concept of the present invention.

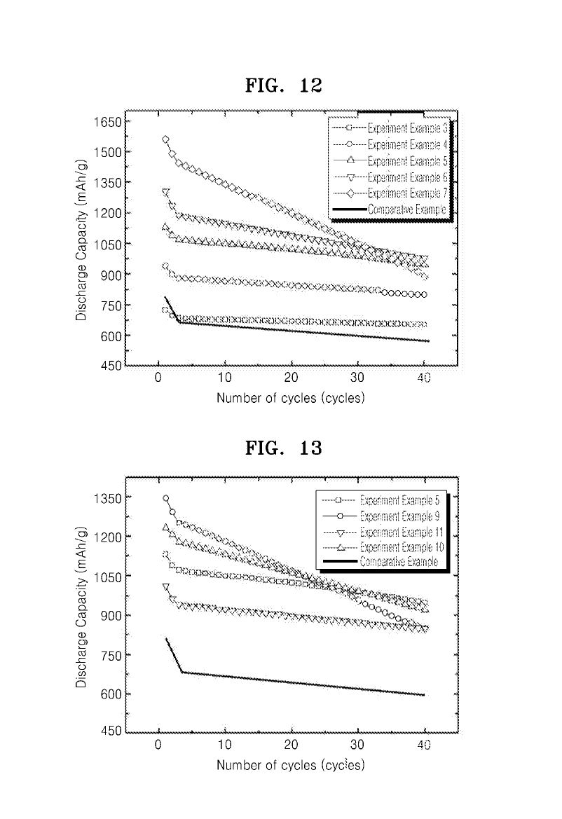

FIGS. 12 and 13 are graphs that illustrate life characteristics of a secondary battery including the anode active material. The graph in FIG. 12 shows the change in discharge capacities according to the change in silicon contents of the anode active material with respect to the different cycles of the Comparative Example and Examples 3, 4, 5, 6, and 7. The graph in FIG. 13 shows the change in discharge capacities and a tendency of the change according to changes in contents of copper and iron in the anode active material with respect to the different cycles of the Comparative Example and Examples 5, 9, 10, and 11.

Referring to FIG. 12, discharge capacities of the cells prepared in Examples 3, 4, 5, 6, and 7 were all higher than that of the cell prepared in the Comparative Example. The discharge capacities increased as the silicon content increased. In Example 7, where the silicon content was about 85 at %, the discharge capacity decrease was relatively rapid as the number of cycles increased.

However, the discharge capacity after the 40^{th} cycle of the cell prepared in Example 7 was still high compared to that of the cell prepared in the Comparative Example.

Referring to FIG. 13, the discharge capacities of the cells prepared in Examples 5, 9, 10, and 11 were all higher compared to that of the cell prepared in the Comparative Example. Also, discharge capacities of the cells prepared in Examples 5, 9, 10, and 11 increased as the content of copper increased. As the number of cycles increased for the cell with a content of copper of about 19 at % (Example 9), the discharge capacity decreased relatively rapid. However, the discharge capacities after the 40^{th} cycle of the cell prepared in Example 9 was higher compared to that of the cell prepared in the Comparative Example.

While the present invention has been particularly shown and described with reference to exemplary embodiments thereof, it will be understood by those of ordinary skill in the art that various changes in form and details may be made therein without departing from the spirit and scope of the present invention as defined by the following claims.

According to an embodiment of the present inventive concept, a secondary battery may have a high initial discharge capacity, a high discharge capacity, and a high capacity retention rate. Also, the secondary battery may have a high economic feasibility by including relatively inexpensive copper and iron.

1. An anode active material for a secondary battery comprising:
one or more first group elements at an amount in the range of about 0 at % to about 30 at %;
one or more second group elements at an amount in the range of about 0 at % to about 40 at %; and
silicon and unavoidable impurities,
wherein the one or more first group elements is selected from the group consisting of: titanium (Ti), nickel (Ni), manganese (Mn), aluminum (Al), chrome (Cr), cobalt (Co), zinc (Zn), boron (B), beryllium (Be), molybdenum (Mo), tantalum (Ta), tungsten (W), sodium (Na), strontium (Sr), phosphorus (P), and a combination thereof, and
the one or more second group elements is selected from the group consisting of: copper (Cu), iron (Fe), and a combination thereof.

2. The anode active material of claim 1 comprising the silicon and unavoidable impurities at an amount in the range of about 60 at % to about 85 at %.

3. The anode active material of claim 1 comprising the silicon and unavoidable impurities at an amount in the range of about 70 at % to about 85 at %.

4. The anode active material of claim 1, wherein the one or more first group elements comprise Ti and Ni in the same amount.

5. The anode active material of claim 1, wherein the one or more second group elements comprise Cu and Fe in the same amount.

6. The anode active material of claim 1, wherein the total amount of the one or more second group elements is greater than the total amount of the one or more first group elements.

7. The anode active material of claim 1 comprises:
the one or more first group elements in an amount in the range of about 0 at % to about 6 at %;
the one or more second group elements in an amount in the range of about 0 at % to about 34 at %; and
the silicon and unavoidable impurities at an amount in the range of about 60 at % to about 85 at %.

8. A secondary battery comprising an anode active material, wherein the anode active material comprises:
a silicon single phase; and
a silicon-metal alloy phase that is distributed around the silicon single phase,
wherein the silicon-metal alloy phase comprises copper, iron, titanium, and nickel.
